(19) United States
(12) Patent Application Publication
(10) Pub. No.: US 2025/0378555 A1
(43) Pub. Date: Dec. 11, 2025

(54) GLOMERULAR DISEASE ASSESSMENT SYSTEM AND METHOD

(71) Applicants: Case Western Reserve University, Cleveland, OH (US); Emory University, Atlanta, GA (US); Duke University, Durham, NC (US); The United States Government as Represented by The Department of Veteran Affairs, Washington, DC (US)

(72) Inventors: Yijiang Chen, Mountain View, CA (US); Anant Madabhushi, Decatur, GA (US); Laura Barisoni, Durham, NC (US)

(21) Appl. No.: 19/223,417

(22) Filed: May 30, 2025

Related U.S. Application Data
(60) Provisional application No. 63/658,075, filed on Jun. 10, 2024.

(51) Int. Cl. G06T 7/00; G01N 1/30; G06V 10/25; G06V 10/26; G06V 10/44

(52) U.S. Cl. CPC G06T 7/0012; G01N 1/30; G06V 10/25; G06V 10/26; G06V 10/44; G06T 2207/20081; G06T 2207/30024; G06T 2207/30084; G06T 2207/30101; G06V 2201/031

(57) ABSTRACT

The present disclosure relates to a method. The method includes accessing a digitized pathology image stored in a memory. The digitized pathology image is from a glomerular disease patient. A plurality of peritubular capillary (PTC) features are extracted from the digitized pathology image. The plurality of PTC features include a plurality of PTC spatial architecture features and a plurality of PTC shape features. The plurality of PTC features are provided to a machine learning stage. The machine learning stage is configured to generate a medical prediction relating to glomerular disease based upon the plurality of PTC features.

### REFERENCE TO RELATED APPLICATION

This Application claims the benefit of U.S. Provisional Application No. 63/658,075, filed on Jun. 10, 2024, the contents of which are incorporated by reference in their entirety.

### BACKGROUND

The glomeruli are networks of tiny blood vessels (e.g., capillaries) located at a beginning of each nephron in a kidney. The glomeruli help clean a person's blood by filtering out waste and/or extra fluids. When the glomeruli are damaged, it's called glomerular disease. The leading cause of glomerular disease is diabetes-related nephropathy.

### BRIEF DESCRIPTION OF THE DRAWINGS

The accompanying drawings, which are incorporated in and constitute a part of the specification, illustrate various example operations, apparatus, methods, and other example embodiments of various aspects discussed herein. It will be appreciated that the illustrated element boundaries (e.g., boxes, groups of boxes, or other shapes) in the figures represent one example of the boundaries. One of ordinary skill in the art will appreciate that, in some examples, one element can be designed as multiple elements or that multiple elements can be designed as one element. In some examples, an element shown as an internal component of another element may be implemented as an external component and vice versa. Furthermore, elements may not be drawn to scale.

FIG. 1 illustrates some embodiments of a glomerular disease assessment apparatus comprising a machine learning stage configured to utilize peritubular capillary (PTC) features to generate a medical prediction of glomerular disease for a patient.

FIG. 2 illustrates some additional embodiments of a glomerular disease assessment apparatus comprising a machine learning stage configured to utilize PTC features to generate a medical prediction of glomerular disease for a patient.

FIGS. 3A-3D illustrate some embodiments of digitized pathology images showing exemplary segmentations.

FIGS. 4A-4B illustrate some embodiments of digitized pathology images showing exemplary PTC features.

FIGS. 5A-5B illustrate tables showing exemplary PTC features that may be utilized by a disclosed machine learning stage to generate a medical prediction of glomerular disease for a patient.

FIG. 6 illustrates some embodiments of digitized pathology images comparing exemplary PTC features for a high-risk patient and a low-risk patient.

FIG. 7 illustrates a flow diagram showing some embodiments of a method of utilizing PTC features to generate a medical prediction of glomerular disease for a patient.

FIG. 8 illustrates some additional embodiments of a glomerular disease assessment apparatus comprising a machine learning stage configured to utilize PTC features to generate a medical prediction of glomerular disease for a patient.

FIG. 9 illustrates some additional embodiments of a glomerular disease assessment apparatus comprising a machine learning stage configured to utilize PTC features to generate a medical prediction of glomerular disease for a patient.

FIGS. 10A-10B illustrate some embodiments graphs showing exemplary Kaplan Meier (KM) curves generated by Cox Proportional Hazards models for different sets of PTC features.

FIG. 11 illustrates a flow diagram showing some additional embodiments of a method of utilizing PTC features to generate a medical prediction of glomerular disease for a patient.

FIG. 12 illustrates some embodiments of a flow chart of a method of generating a glomerular disease assessment apparatus configured to generate a medical prediction relating to glomerular disease.

FIG. 13 illustrates a block diagram of some embodiments of a glomerular disease assessment system comprising a machine learning circuit configured to utilize PTC features to generate a medical prediction of glomerular disease for a patient.

### DETAILED DESCRIPTION

The description herein is made with reference to the drawings, wherein like reference numerals are generally utilized to refer to like elements throughout, and wherein the various structures are not necessarily drawn to scale. In the following description, for purposes of explanation, numerous specific details are set forth in order to facilitate understanding. It may be evident, however, to one of ordinary skill in the art, that one or more aspects described herein may be practiced with a lesser degree of these specific details. In other instances, known structures and devices are shown in block diagram form to facilitate understanding.

The renal interstitial microvasculature is composed of glomerular capillaries and peritubular capillaries. The glomerular capillaries are involved in an initial filtration of blood in a kidney. The peritubular capillaries (PTCs) play an important role in modulating the excretion of waste and excess water, the reabsorption of amino acids, minerals, and glucose, and the blood and oxygen supply to functional parts of a kidney (e.g., the kidney parenchyma).

It has been appreciated that changes in the PTCs can affect a surrounding interstitial microenvironment (e.g., tubulointerstitium). For example, PTC structural abnormalities (e.g., changes in shape) may contribute to decreased blood flow and oxygenation of the renal parenchyma, in turn potentially resulting in a causative relationship with fibrosis formation. It has also been appreciated that PTC characteristics (e.g., describing a spatial architecture and/or shape of PTC) and their modulation in the presence of an interstitial microenvironment may be determinant of progression in kidney diseases. For example, because PTCs help to supply oxygen to kidney cells, a decrease in their number may result in an ischemic microenvironment, scarring, and loss of function. Understanding how PTCs and the neighboring tubulointerstitium affect each other may provide insights into the mechanisms underlying disease progression, and potentially unveil novel digital biomarkers or therapeutic targets for kidney diseases.

The present disclosure relates to a method of assessing glomerular disease in a patient using a machine learning model configured to utilize peritubular capillary (PTC) features to generate a medical prediction. In some embodiments, the method may comprise accessing a digitized pathology image stored in a memory. A plurality of peritubular capillary (PTC) features are extracted from the digitized pathology image. The plurality of PTC features include spatial architecture features and shape features. The plurality of PTC features are provided to a machine learning model, which is configured to generate a medical prediction relating to glomerular disease based upon the plurality of PTC features. Because changes in PTCs affect a surrounding interstitial microenvironment, the operation of the machine learning model on the PTC features can generate a medical prediction that takes into account an interplay between a status of a kidney microvasculature (e.g., peritubular capillaries) and a neighboring interstitial microenvironment (e.g., interstitial fibrosis and tubular atrophy (IFTA)) in glomerular diseases, thereby providing for a highly accurate prediction relating to glomerular disease progression.

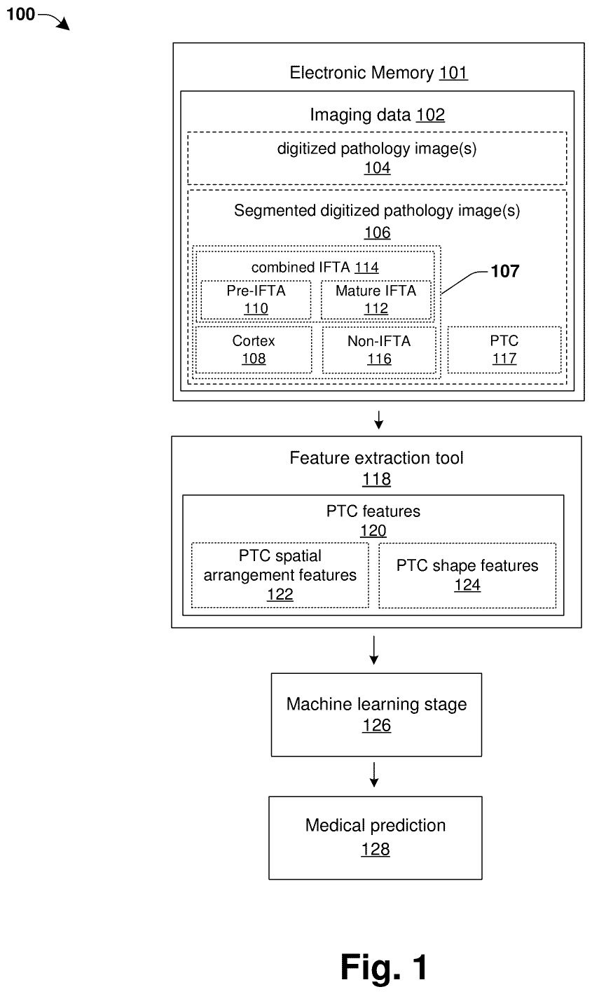

FIG. 1 illustrates some embodiments of a glomerular disease assessment apparatus 100 comprising a machine learning stage configured to utilize peritubular capillary (PTC) features to generate a medical prediction of glomerular disease for a patient.

The glomerular disease assessment apparatus 100 comprises an electronic memory 101 configured to store imaging data 102 for a glomerular disease patient (e.g., a patient that has and/or is suspected of having glomerular disease). In some embodiments, the imaging data 102 may comprise one or more digitized pathology images 104 (e.g., digitized biopsy images, a whole slide image (WSI), etc.) of a tissue sample taken from the glomerular disease patient. In some embodiments, the imaging data 102 may comprise one or more segmented digitized pathology images 106 that respectively identify one or more regions of interest 107 (e.g., volumes of interest) within a WSI. In some embodiments, the one or more segmented digitized pathology images 106 may further comprise segmented peritubular capillaries (PTCs) 117.

The one or more regions of interest 107 may include regions that describe different stages (e.g., progressions) and/or classifications of interstitial fibrosis and tubular atrophy (IFTA) (e.g., a scarring and degeneration in a kidney that marks irreversible renal injury). For example, the one or more regions of interest 107 may include one or more of a cortex 108 (e.g., a cortical region), a pre-IFTA region 110, a mature IFTA region 112, a combined IFTA region 114, and a non-IFTA region 116. In some embodiments, the cortex 108 includes substantially an entire area of a kidney section within a digitized pathology image of the one or more digitized pathology images 104. In some embodiments, the cortex 108 may exclude arcuate arteries and medullary rays. In some embodiments, the pre-IFTA region 110 includes a region having tubular cells that have maintained some characteristics of originating tubules (e.g., resembling proximal or distal tubules), but that exhibit thickened tubular basement membrane separated by interstitial fibrosis. In some embodiments, the mature IFTA region 112 includes tubules that are fully atrophic tubules (e.g., small tubules with very thick tubular basement membranes) and that are separated by dense interstitial fibrosis. In some embodiments, the combined IFTA region 114 is a region that includes both the pre-IFTA region 110 and the mature IFTA region 112. In some embodiments, non-IFTA region 116 is a region that does not include either the pre-IFTA region 110 or the mature IFTA region 112. For example, the non-IFTA region 116 may include the cortex 108 minus the pre-IFTA region 110 and the mature IFTA region 112.

A feature extraction tool 118 is configured to extract a plurality of peritubular capillaries (PTC) features 120 from the one or more regions of interest 107 and/or the PTCs 117 within the imaging data 102 (e.g., within the one or more segmented digitized pathology images 106). For example, the plurality of PTC features 120 may be extracted from one or more of the cortex 108, the pre-IFTA region 110, the mature IFTA region 112, the combined IFTA region 114, and the non-IFTA region 116. In some embodiments, the plurality of PTC features 120 may include PTC spatial arrangement features 122 (e.g., features describing a spatial arrangement of PTCs) and/or PTC shape features 124 (e.g., features describing a shape of one or more PTCs). In some embodiments, the PTC spatial arrangement features 122 may include first and second-order statistics of Voronoi diagrams, Delaunay triangulations, minimum spanning trees, PTC density, co-occurring PTC tensors, subgraph features, and/or the like. In some embodiments, the PTC shape features 124 may include an average shape of all the PTCs in an image, including area, perimeter, aspect ratio, eccentricity, Fourier descriptors, and/or the like. By using features from different ones of the one or more regions of interest 107, the plurality of PTC features 120 can be used to assess an interplay between PTC and different stages of IFTA (e.g., different stages of scarring).

In some embodiments, the plurality of PTC features 120 may include PTC spatial arrangement features 122 extracted from the non-IFTA region 116 and PTC shape features extracted from the combined IFTA region 114. It has been appreciated that PTC spatial arrangement features 122 extracted from the non-IFTA region 116 are prognostic of disease progression. Similarly, it has been appreciated that PTC shape features extracted from IFTA regions (e.g., the pre-IFTA region 110, the mature IFTA region 112, and/or the combined IFTA region 114) are prognostic of disease progression.

A machine learning stage 126 (e.g., comprising one or more machine learning models) is configured to utilize the plurality of PTC features 120 to generate a medical prediction 128 relating to glomerular disease. By utilizing the plurality of PTC features 120, the machine learning stage 126 may be able to generate the medical prediction 128 relating to glomerular disease with a high degree of accuracy. This is because the plurality of PTC features 120 enable the machine learning stage 126 to take into account an interplay between a kidney microvasculature and a neighboring interstitial microenvironment. It has been appreciated that this interplay is prognostic of progression of glomerular diseases.

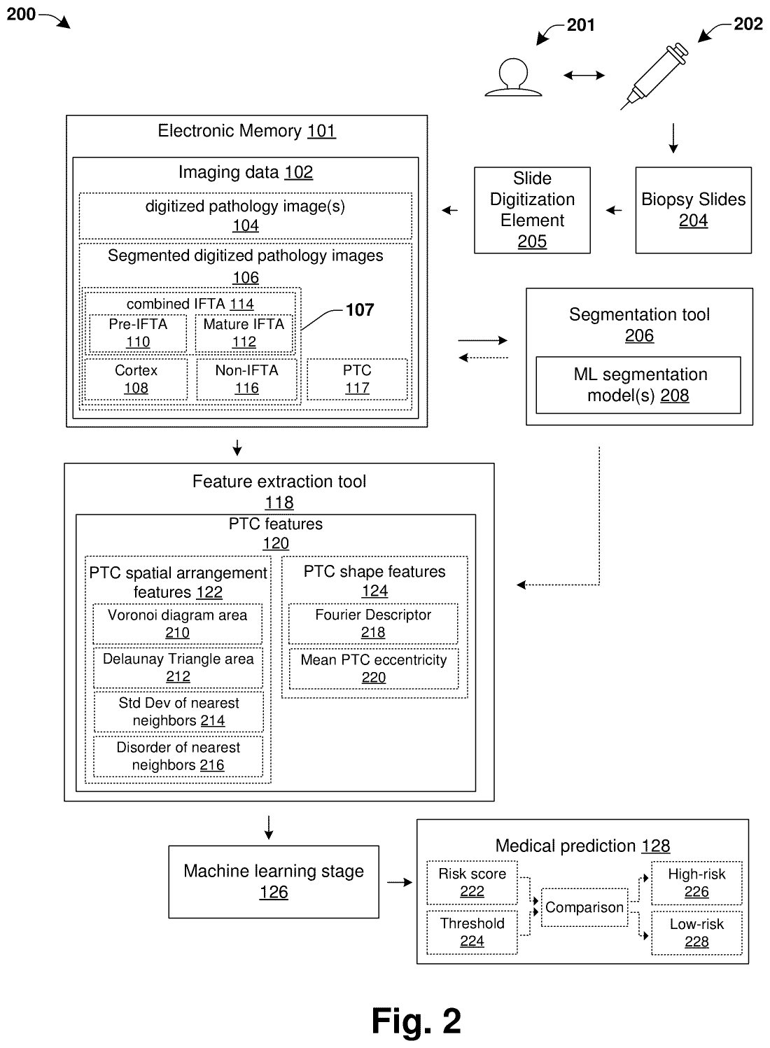

FIG. 2 illustrates some additional embodiments of a glomerular disease assessment apparatus 200 comprising a machine learning stage configured to utilize PTC features to generate a medical prediction of glomerular disease for a patient.

The glomerular disease assessment apparatus 200 comprises imaging data 102 stored in an electronic memory 101. In some embodiments, the electronic memory 101 may comprise a solid state memory, SRAM (static random-access memory), DRAM (dynamic random-access memory), and/or the like. In some embodiments, the imaging data 102 may comprise one or more digitized pathology images 104. In some embodiments, the imaging data 102 may comprise one or more segmented digitized pathology images 106 that respectively identify one or more regions of interest 107. In some embodiments, the one or more regions of interest 107 may comprise one or more of a cortex 108 (e.g., a cortical region), a pre-IFTA (interstitial fibrosis and tubular atrophy) region 110, a mature IFTA region 112, a combined IFTA region 114 (e.g., a region that includes both the pre-IFTA region 110 and the mature IFTA region 112), and a non-IFTA region 116. In some embodiments, the one or more segmented digitized pathology images 106 may further comprise segmented PTCs 117.

In some embodiments, the imaging data 102 may be obtained from a pathological tissue sample taken from the glomerular disease patient 201. In some such embodiments, a tissue sample collection tool 202 is used to perform a biopsy on the glomerular disease patient 201 to obtain a tissue block. The tissue block is sliced into thin slices that are placed on one or more transparent slides (e.g., one or more glass slides). The tissue on the one or more transparent slides is then stained to generate one or more biopsy slides 204. The one or more biopsy slides 204 are subsequently converted to a plurality of whole slide images (WSIs) comprising the digitized pathology image. In some embodiments, the digitized pathology image may comprise a digitized PAS (periodic acid Schiff) stained slide, an H&E (Hematoxylin and eosin) stained slide, or the like. In some embodiments, the glomerular disease assessment apparatus 200 may comprise a slide digitization element 205 that is configured to generate the one or more digitized pathology images 104 from the one or more biopsy slides 204. In some embodiments, the slide digitization element 205 may comprise a slide reception surface configured to receive the one or more biopsy slides 204 and an image sensor (e.g., a photodiode, CMOS image sensor, or the like) disposed within a housing and configured to generate a digitized image of the one or more biopsy slides 204 on the slide reception surface.

In some embodiments, a segmentation tool 206 is configured to access the imaging data 102. The segmentation tool 206 is configured to segment the one or more digitized pathology images 104 to generate the one or more segmented digitized pathology images 106. In some embodiments, the segmentation tool 206 comprises one or more machine learning segmentation models 208. The one or more machine learning segmentation models 208 may be configured to identify the one or more regions of interest 107 and/or the PTCs 117. In some embodiments, the one or more machine learning segmentation models 208 may comprise and/or be deep learning models. It has been appreciated that due to the extremely large number of PTCs within a digitized pathology image, it is not practically possible for humans to segment the image to identify the PTCs 117. However, the one or more machine learning segmentation models 208 (e.g., deep learning models) are able to accurately segment the one or more digitized pathology images 104 to identify the PTCs 117.

In some embodiments, the one or more machine learning segmentation models 208 may comprise one or more deep learning models run on one or more processors (e.g., a central processing unit including one or more transistor devices configured to operate computer code to achieve a result, a microcontroller, a graphics processing unit (GPU), and/or the like). For example, the one or more machine learning segmentation models 208 may comprise a graphical neural network (GNN). In some embodiments, the one or more machine learning segmentation models 208 are configured to generate binary masks that identify the cortex 108, the pre-IFTA region 110, the mature IFTA region 112, the combined IFTA region 114, and/or the non-IFTA region 116. In some such embodiments, the one or more binary masks may comprise or be images having a value of “1” in image units (e.g., pixels, voxels, etc.) identified as being within one of the one or more regions of interest 107 and having a value of “0” in image units outside of the one of the one or more regions of interest 107.

A feature extraction tool 118 is configured to extract a plurality of peritubular capillary (PTC) features 120 (e.g., PTC pathomic features) from the one or more regions of interest 107 and/or the PTCs 117. The plurality of PTC features 120 include PTC spatial arrangement features 122 (e.g., features describing a spatial arrangement of PTCs) and/or PTC shape features 124 (e.g., features describing a shape of one or more PTCs). In some embodiments, the plurality of PTC spatial arrangement features 122 may comprise one or more of a Voronoi diagram area 210, a Delaunay Triangle area 212, a standard deviation of nearest neighbors 214, and a disorder of nearest neighbors 216. In some embodiments, the plurality of PTC shape features 124 may comprise one or more of a Fourier Descriptor 218 and a mean PTC eccentricity 220 extracted from the combined IFTA region 114. In some embodiments, the PTC spatial arrangement features 122 may be extracted from the non-IFTA region 116 and the PTC shape features 124 may be extracted from the combined IFTA region 114.

A machine learning stage 126 is configured to operate upon the plurality of PTC features 120 to generate a medical prediction 128 relating to glomerular disease. In some embodiments, the machine learning stage 126 is configured to operate upon the plurality of PTC features 120 to generate a risk score 222 that is indicative of the patient's risk of glomerular disease progression. For example, the risk score 222 may be compared to a threshold 224 to identify the glomerular disease patient 201 as having a high-risk 226 of glomerular disease progression or a low-risk 228 of glomerular disease progression. In some embodiments, the risk score 222 may be computed as a linear combination of weights to the PTC features 120 and associated values. In some embodiments, the medical prediction 128 relating to glomerular disease may be defined by a time from biopsy to a 40% decline in eGFR (estimated glomerular filtration rate) (e.g., with eGFR<90 mL/min/1.73 m²) or kidney failure (e.g., dialysis, transplant, or two consecutive eGFRs<15 mL/min/1.73 m²).

In some embodiments, the machine learning stage 126 may comprise a regression model, a Cox Hazard regression model, a support vector machine (SVM), a linear discriminant analysis (LDA) classifier, a NaÏve Bayes classifier, a Random Forest, Adaboost, and/or the like. In some embodiments, the machine learning stage 126 may be run on one or more processors (e.g., a central processing unit including one or more transistor devices configured to operate computer code to achieve a result, a microcontroller, a GPU, and/or the like).

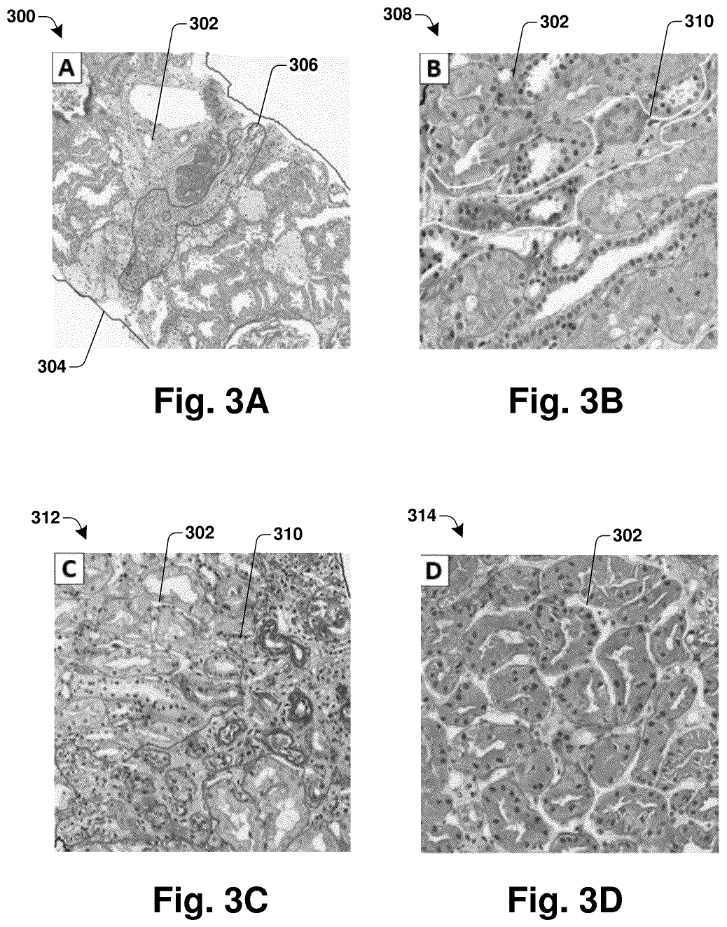

FIGS. 3A-3D illustrate some embodiments of digitized pathology images showing exemplary segmentations that may be achieved according to a disclosed segmentation tool (e.g., segmentation tool 206 of FIG. 2).

FIG. 3A illustrates a segmented digitized pathology image 300 of kidney tissue. Within the segmented digitized pathology image 300, peritubular capillaries (PTCs) 302 are highlighted in green, cortical regions 304 are highlighted in black, and mature interstitial fibrosis and tubular atrophy (IFTA) regions 306 are highlighted in red. As can be seen in the segmented digitized pathology image 300, the mature IFTA regions 306 and the PTC 302 are within the cortical regions 304.

FIG. 3B illustrates an additional segmented digitized pathology image 308 of kidney tissue. Within the additional segmented digitized pathology image 308, PTCs 302 are highlighted in green and pre-IFTA regions 310 are highlighted in yellow. As can be seen in the additional segmented digitized pathology image 308, the PTCs 302 are within the pre-IFTA regions 310.

FIG. 3C illustrates an additional segmented digitized pathology image 312 of kidney tissue. Within the additional segmented digitized pathology image 312, PTCs 302 are highlighted in green and mature IFTA regions 306 are highlighted in red. As can be seen in the additional segmented digitized pathology image 312, the PTCs 302 are within the mature IFTA regions 306.

FIG. 3D illustrates an additional segmented digitized pathology image 314 of kidney tissue. Within the additional segmented digitized pathology image 314, PTCs 302 are highlighted in green.

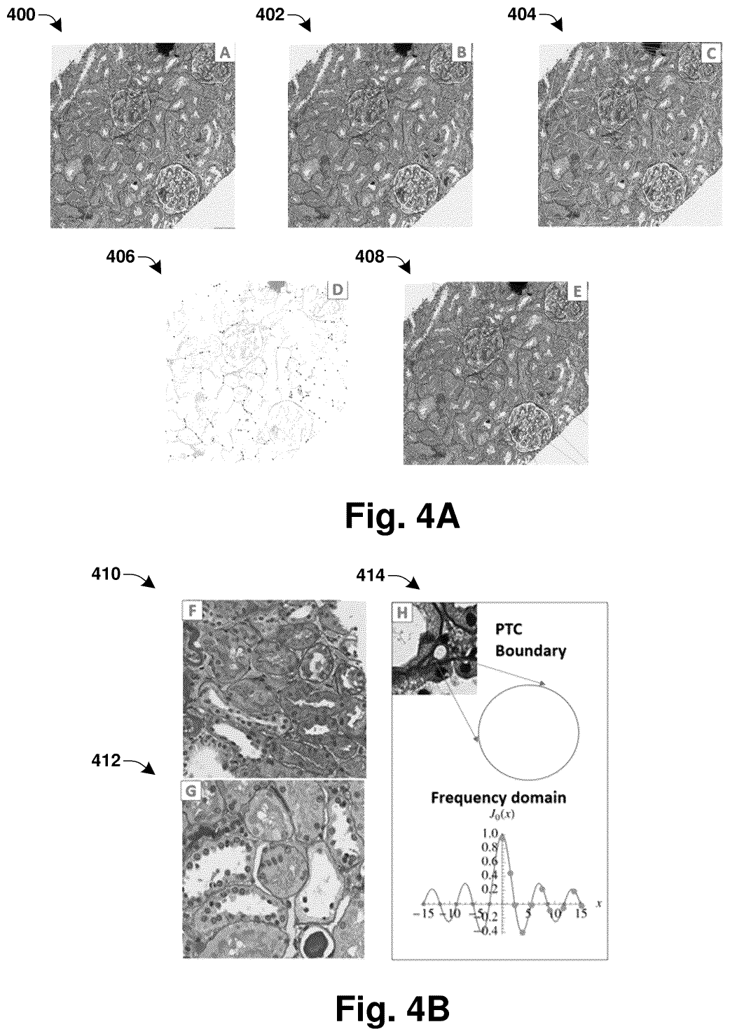

FIGS. 4A-4B illustrate some embodiments of digitized pathology images showing exemplary PTC features that may be extracted by a feature extraction tool (e.g., feature extraction tool 118 of FIG. 2).

FIG. 4A illustrates non-IFTA regions with examples of spatial architecture features. Image 400 illustrates an example of a spatial architecture feature comprising a minimum spanning tree (shown in green) on a digitized pathology image. Image 402 illustrates an example of a spatial architecture feature comprising a nearest neighbor (e.g., PTCs with the shortest average distance to nearest neighbors are highlighted in darkest blue on the digitized pathology image). Image 404 illustrates an example of a spatial architecture feature comprising Delaunay triangulation on the digitized pathology image. Image 406 illustrates an example of a spatial architecture feature comprising a Local PTC cluster graph on the digitized pathology image. Image 408 illustrates an example of a spatial architecture feature comprising a Voronoi Diagram on the digitized pathology image.

FIG. 4B illustrates non-IFTA regions with examples of PTC shape features. Image 410 illustrates an example of a PTC shape feature comprising a PTC aspect ratio heatmap on a digitized pathology image. The PTC aspect ratio heatmap illustrates highest values of PTC aspect ratios as being highlighted in dark red, and lowest values of PTC aspect ratios as being highlighted in dark blue. Image 412 illustrates an example of a PTC shape feature comprising a PTC eccentricity heatmap on a digitized pathology image. The PTC eccentricity heatmap illustrates highest values of PTC eccentricity as being highlighted in dark red, and lowest values of PTC eccentricity as being highlighted in dark blue. Image 414 illustrates an example of a PTC shape feature comprising Fourier shape descriptors on a digitized pathology image.

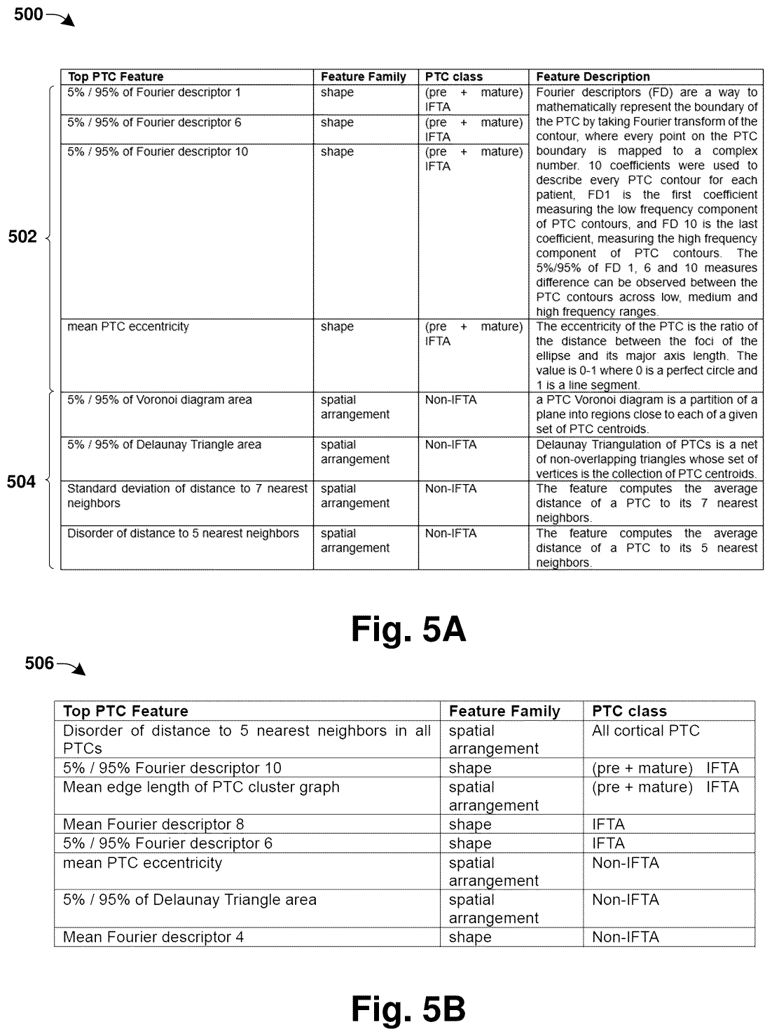

FIGS. 5A-5B illustrate tables showing exemplary PTC features that may be utilized by a machine learning stage to generate a medical prediction of glomerular disease for a patient.

FIG. 5A illustrates a table 500 showing some embodiments of exemplary PTC features that may be utilized by a machine learning stage to generate a medical prediction of glomerular disease for a patient. The table 500 lists PTC features and a short explanation of each feature. The PTC features include both PTC shape features 502 extracted from a combined IFTA region and PTC spatial architecture features 504 extracted from a non-IFTA region. These PTC features were found to be highly prognostic of glomerular disease progression.

In some embodiments, the PTC shape features 502 are indicative of heterogeneity of PTC shapes (e.g., variation in PTC shapes). It has been appreciated that heterogeneity of PTC shapes can be indicative of disease progression (e.g., higher variation of PTC shapes is less indicative of disease progression than lower variation of PTC shapes). For example, the presence of PTC with extreme values of Fourier descriptors within an IFTA region indicate greater variations in PTC shapes and are associated with better clinical outcome (e.g., slower disease progression). In contrast, patients with low shape variability (e.g., higher values of 5%/95% in Fourier descriptors 1, 6, and 10) and small round PTCs (e.g., a low eccentricity) in an IFTA region are associated with worse clinical outcome (e.g., faster disease progression).

In some embodiments, the PTC spatial architecture features 504 may be indicative of heterogeneity of PTC spatial arrangement (e.g., variation in PTC spatial arrangements). For example, PTC spatial architecture features extracted from a non-IFTA region reflect the heterogeneity in the spatial distribution of PTCs. It has been appreciated that heterogeneity of PTC spatial arrangements can be indicative of disease progression (e.g., higher variations in PTC spatial arrangements is more indicative of disease progression than lower variations in PTC spatial arrangements). Lower values of 5%/95% of Voronoi diagram area and Delaunay triangle area and higher values in Standard deviation of distance to 7 nearest neighbors and Disorder of distance to 5 nearest neighbors corresponded to a more uniform distribution of PTCs throughout the non-IFTA regions and a lower risk of disease progression.

The combined 4 PTC shape features in IFTA regions may be prognostic of disease progression. Therefore, in some embodiments the plurality of PTC shape features may include all 4 PTC shape features in the IFTA regions. In non-IFTA regions, PTC spatial architecture features may be associated with disease progression in combination and independently. Therefore, in some embodiments the plurality of PTC spatial architecture features may include one or more of the 4 PTC spatial architecture features in the non-IFTA regions.

FIG. 5B illustrates a table 506 showing some additional embodiments of exemplary PTC features that may be utilized by a machine learning model to generate a medical prediction of glomerular disease for a patient.

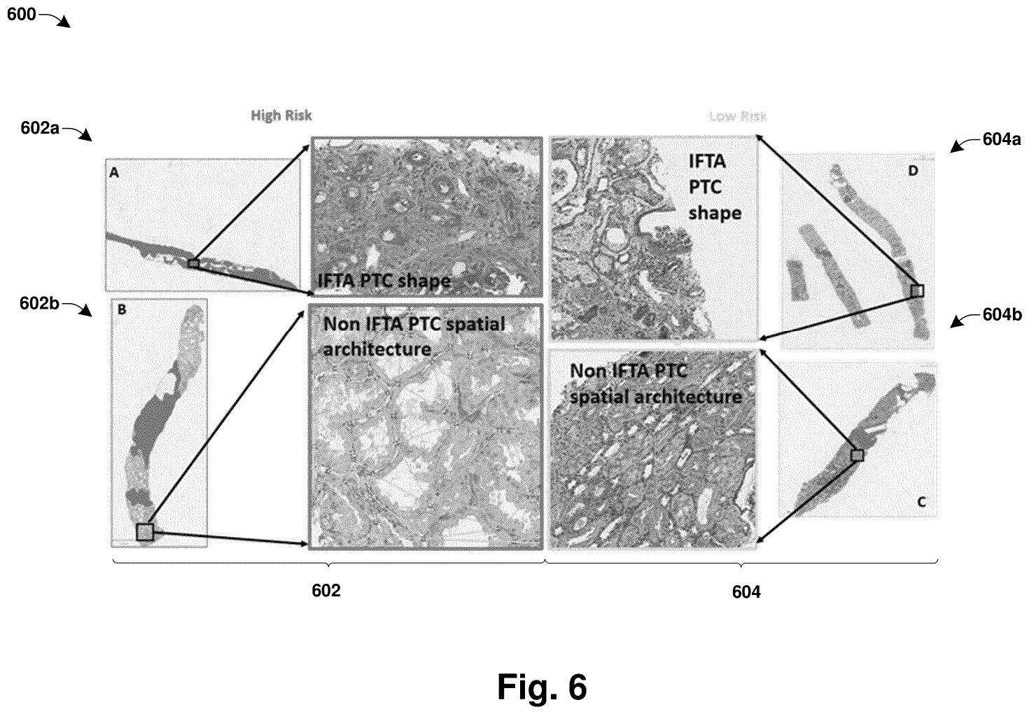

FIG. 6 illustrates some embodiments of digitized pathology images 600 showing exemplary PTC features for a high-risk patient (e.g., a patient at high-risk of glomerular disease) and a low-risk patient (e.g., a patient at low-risk of glomerular disease).

The digitized pathology images 600 (e.g., thumbnails of whole slide images (WSIs)) show exemplary PTC features for a high-risk patient 602 and exemplary PTC features for a low-risk patient 604. Within the digitized pathology images, 602-604, mature IFTA regions are shown in red and pre-IFTA regions are shown in yellow. The digitized pathology images, 602-604, illustrate an interplay between PTC and IFTA.

Digitized pathology image 602a illustrates an IFTA region of a high-risk patient. The digitized pathology image 602a comprises a red circle highlighting light blue PTCs with small Fourier Descriptor feature values and a yellow circle highlighting the dark blue PTCs with large Fourier Descriptor feature values. There is high percentage of combined IFTA regions containing PTCs with small variations in shape feature values (PTCs uniformly compressed). This pathomic signature is associated with high-risk of glomerular disease progression.

Digitized pathology image 602b illustrates a non-IFTA region of a high-risk patient. The digitized pathology image 602b comprises Delaunay triangulations with PTCs being the vertices. Extremely large and small diagrams can be observed on the cortex, thereby indicating heterogeneous PTC distribution in the non-IFTA regions.

Digitized pathology image 604a illustrates an IFTA region of a low-risk patient showing PTCs of variable shapes. In this digitized pathology image 604a, there is relatively lower percentage of combined IFTA regions containing larger PTCs in IFTA regions, with more various shapes and less compression, as indicated by higher and more diverse Fourier Descriptor values.

Digitized pathology image 604b illustrates a non-IFTA region of a low-risk patient showing Delaunay triangulations. In this digitized pathology image 604b, the Delaunay triangulations have more uniform sizes than those of the high-risk patient (shown in digitized pathology image 602b), thereby indicating a more uniform distribution of PTCs across the cortex.

Therefore, it has been appreciated that patients with homogenously shaped (e.g., small and round) PTCs in IFTA regions and with a heterogeneous distribution of PTCs in non-IFTA regions have more rapid disease progression. This shows that the spatial architecture features in non-IFTA regions can serve as digital biomarkers of risk of progression, independently from the amount of overall IFTA. These observations underscore the link between PTC shape and spatial architecture features in both IFTA and non-IFTA regions with patient risk profiles, highlighting the significance of PTC heterogeneity in predicting glomerular disease progression.

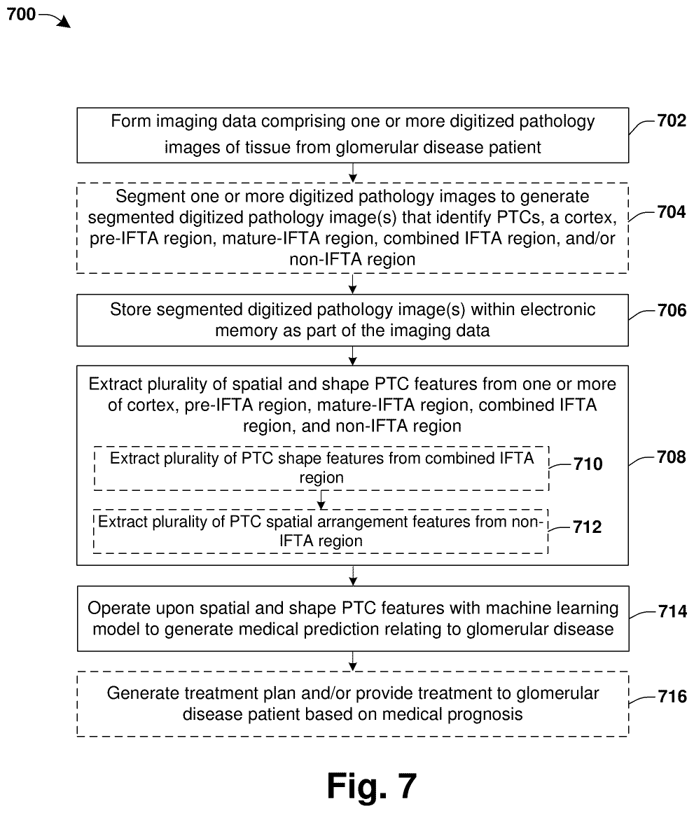

FIG. 7 illustrates a flow diagram showing some embodiments of a method 700 of utilizing PTC features to generate a medical prediction of glomerular disease for a patient.

While the disclosed methods (e.g., method 700 and/or method 1100) are illustrated and described herein as a series of acts or events, it will be appreciated that the illustrated ordering of such acts or events are not to be interpreted in a limiting sense. For example, some acts may occur in different orders and/or concurrently with other acts or events apart from those illustrated and/or described herein. In addition, not all illustrated acts may be required to implement one or more aspects or embodiments of the description herein. Further, one or more of the acts depicted herein may be carried out in one or more separate acts and/or phases.

At act 702, imaging data is formed to comprise one or more digitized pathology images of tissue from a glomerular disease patient. In some embodiments, the imaging data may comprise one or more digitized pathology images including a digitized PAS (periodic acid Schiff) stained slide. In some such embodiments, the imaging data is formed by taking a tissue sample from the glomerular disease patient, separating the tissue sample into a plurality of tissue slices, staining one or more of the plurality of tissue slices to form one or more stained tissue slices, forming one or more biopsy slides using the one or more stained tissue slices, and digitizing the one or more stained tissue slices to form the one or more digitized pathology images.

At act 704, in some embodiments the one or more digitized pathology images may be segmented to generate one or more segmented digitized pathology images that identify one or more of peritubular capillaries (PTCs), a cortex, a pre-IFTA region, a mature-IFTA region, a combined IFTA region, and a non-IFTA region.

At act 706, the one or more segmented digitized pathology images are stored within electronic memory as part of the imaging data.

At act 708, a plurality of spatial and shape PTC features are extracted from one or more of the cortex, the pre-IFTA region, the mature-IFTA region, the combined IFTA region, and the non-IFTA region. In some embodiments, the extraction of spatial and shape PTC features may be performed according to acts 710-712.

At act 710, a plurality of PTC shape features are extracted from the combined IFTA region.

At act 712, a plurality of PTC spatial arrangement features are extracted from a non-IFTA region.

At act 714, the plurality of spatial and shape PTC features are operated upon by a machine learning model to generate a medical prediction relating to glomerular disease.

At act 716, a treatment plan may be generated and/or a treatment may be provided to the glomerular disease patient based upon the medical prediction, in some embodiments. For example, based upon the medical prediction it may be determined that certain treatments (e.g., medications, dialysis, a kidney transplant, etc.) may be beneficial to the glomerular disease patient and the treatment may be applied to the glomerular disease patient.

It will be appreciated that the disclosed methods and/or block diagrams may be implemented as computer-executable instructions, in some embodiments. Thus, in one example, a computer-readable storage device (e.g., a non-transitory computer-readable medium) may store computer executable instructions that if executed by a machine (e.g., computer, processor) cause the machine to perform the disclosed methods and/or block diagrams. While executable instructions associated with the disclosed methods and/or block diagrams are described as being stored on a computer-readable storage device, it is to be appreciated that executable instructions associated with other example disclosed methods and/or block diagrams described or claimed herein may also be stored on a computer-readable storage device.

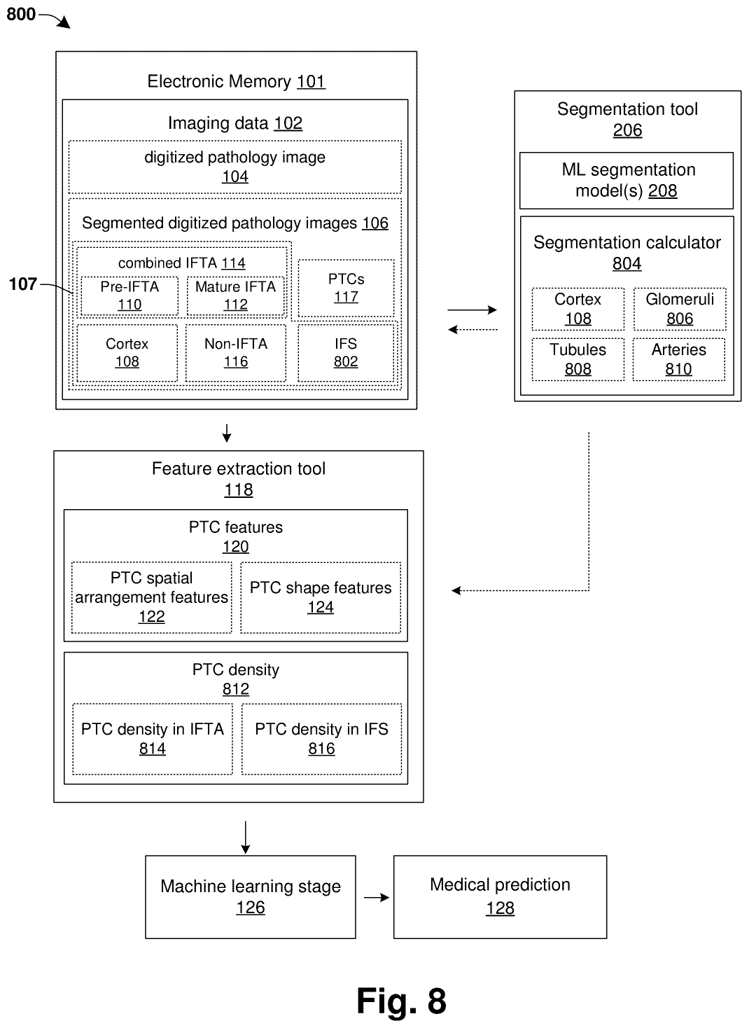

FIG. 8 illustrates some additional embodiments of a glomerular disease assessment apparatus 800 comprising a machine learning stage configured to utilize PTC features to generate a medical prediction of glomerular disease for a patient.

The glomerular disease assessment apparatus 800 comprises imaging data 102 stored in an electronic memory 101. The imaging data 102 comprises digitized pathology imaging data for a glomerular disease patient 201. In some embodiments, the imaging data 102 may comprise one or more digitized pathology images 104 of tissue from the glomerular disease patient 201.

In some embodiments, a segmentation tool 206 is configured to access the imaging data 102. The segmentation tool 206 is configured to segment the one or more digitized pathology images 104 to generate one or more segmented digitized pathology images 106. In some embodiments, the one or more segmented digitized pathology images 106 include images that respectively identify one or more regions of interest 107. In some embodiments, the one or more regions of interest 107 may comprise one or more of a cortex 108, a pre-IFTA region 110, a mature IFTA region 112, a combined IFTA region 114, a non-IFTA region 116. In some additional embodiments, the one or more regions of interest 107 may comprise an IFS (interstitial fractional space) region 802 (e.g., a space within a kidney's parenchyma, surrounding tubules, blood vessels, and glomeruli). The segmented digitized pathology images 106 may further identify PTCs 117.

In some embodiments, the segmentation tool 206 comprises one or more machine learning segmentation models 208. In some additional embodiments, the segmentation tool 206 may further comprise a segmentation calculator 804. In some embodiments, the one or more machine learning segmentation models 208 may be configured to perform a segmentation that automatically identifies glomeruli 806, tubules 808, and arteries 810. The segmentation calculator 804 may subsequently subtract the glomeruli 806, tubules 808, and arteries 810 from the cortex 108 to identify the IFS region 802. In some embodiments, the machine learning segmentation models 208 may comprise a deep learning model.

A feature extraction tool 118 is configured to extract a plurality of peritubular capillary (PTC) features 120 from the one or more regions of interest 107 within the one or more segmented digitized pathology images 106. The plurality of PTC features 120 include PTC spatial arrangement features 122 and PTC shape features 124. In some additional embodiments, the feature extraction tool 118 is further configured to extract one or more PTC density features 812. The one or more PTC density features 812 may comprise a PTC density in an IFTA 814 (e.g., in the pre-IFTA region 110, the mature IFTA region 112, a combined IFTA region 114) and/or a PTC density in IFS 816.

A machine learning stage 126 is configured to operate upon the plurality of PTC features 120 and/or the one or more PTC density features 812 (e.g., the PTC density in IFS 816) to generate a medical prediction 128 relating to glomerular disease. In some embodiments, the machine learning stage 126 may be configured to generate the medical prediction 128 to have an inverse relationship between PTC density (e.g., PTC density in IFTA) and glomerular disease outcome. For example, higher PTC densities may correspond to worse glomerular disease outcomes.

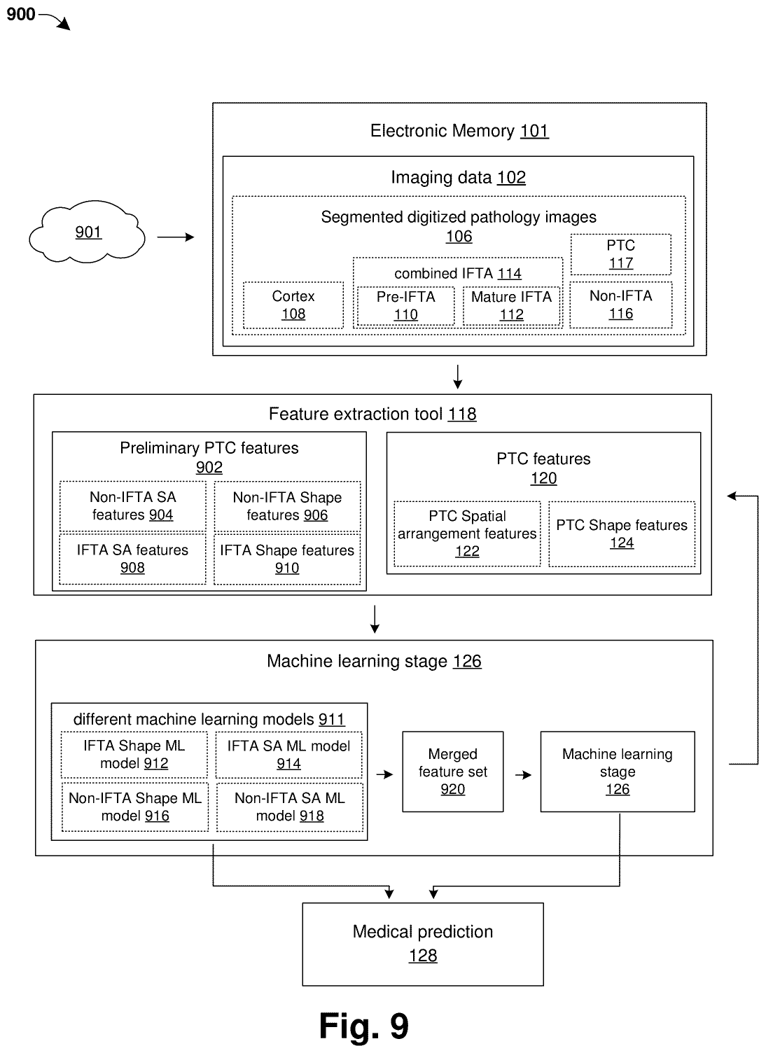

FIG. 9 illustrates some additional embodiments of a glomerular disease assessment apparatus 900 comprising a machine learning stage configured to utilize PTC features to generate a medical prediction of glomerular disease for a patient.

The glomerular disease assessment apparatus 900 comprises imaging data 102 stored in an electronic memory 101. The imaging data 102 comprises digitized pathology imaging data for a glomerular disease patient 201. In some embodiments, the imaging data 102 may comprise one or more digitized pathology images 104 of tissue from the glomerular disease patient 201. In some embodiments, the imaging data 102 may comprise one or more digitized pathology images downloaded from an online database 901 (e.g., an online archive). In some embodiments, the one or more digitized pathology images 104 within the imaging data 102 may be separated into one or more training sets and one or more validation sets. In some embodiments, the one or more digitized pathology images 104 may be separated into one or more training and validation sets in a manner that ensures a balanced representation of digitized images from patients with different outcomes over various time periods.

A feature extraction tool 118 is configured to extract a plurality of preliminary peritubular capillary (PTC) features 902 from one or more regions of interest within the one or more segmented digitized pathology images 106. The plurality of preliminary PTC features 902 may be extracted from different combinations of PTC families and IFTA regions. For example, the plurality of preliminary PTC features 902 may include non-IFTA spatial architecture features 904 (e.g., spatial architecture features extracted from a non-IFTA region), non-IFTA shape features 906 (e.g., shape features extracted from a non-IFTA region), IFTA spatial architecture features 908 (e.g., spatial architecture features extracted from an IFTA region), and IFTA shape features 910 (e.g., shape features extracted from an IFTA region). The plurality of PTC features may include a plurality of PTC features 120 including PTC spatial arrangement features 122 and PTC shape features 124. By using features from different IFTA regions, the plurality of PTC features can be used to assess an interplay between the PTC and different stages of IFTA.

A machine learning stage 126 is configured to operate upon the plurality of preliminary PTC features 902 to generate a medical prediction 128 relating to glomerular disease. In some embodiments, to assess independent prognostic values of different PTC feature families (e.g., 230 shape and spatial arrangement features) across any IFTA region (e.g., a pre-IFTA region, a mature IFTA region, and a combined IFTA region), and non-IFTA regions, the machine learning stage 126 may comprise a plurality of different machine learning models 911 trained to be prognostic for different categories of PTC feature families. The plurality of different machine learning models 911 may respectively comprise a Least Absolute Shrinkage and Selection Operator (LASSO) and Cox based multi-feature prognostic model. The plurality of different machine learning models 911 may be tested upon a training data set to identify top prognostic features (e.g., a top four features) for each category. The plurality of different machine learning models 911 may subsequently be validated on the validation set.

For example, the plurality of different machine learning models 911 may comprise an IFTA shape machine learning model 912, an IFTA spatial arrangement machine learning model 914, a non-IFTA shape machine learning model 916, and a non-IFTA spatial arrangement machine learning model 918. The IFTA shape machine learning model 912 may be constructed to identify prognostic features (e.g., a top 4 features) from a pool of PTC shape features (e.g., 690 shape features) extracted from PTCs in any IFTA regions (e.g., pre IFTA, mature IFTA, and combined pre-FTA and mature IFTA). The IFTA spatial arrangement machine learning model 914 may be constructed to identify prognostic features (e.g., a top 4 features) from a pool of PTC spatial arrangement features (e.g., 690 shape features) extracted from PTCs in any IFTA regions (e.g., pre IFTA, mature IFTA, and combined pre-FTA and mature IFTA). The non-IFTA shape machine learning model 916 may be constructed to identify prognostic features (e.g., a top 4 features) from a pool of PTC shape features (e.g., 690 shape features) extracted from PTCs in non-IFTA regions. The non-IFTA spatial arrangement machine learning model 918 may be constructed to identify prognostic features (e.g., a top 4 features) from a pool of PTC spatial arrangement features (e.g., 690 shape features) extracted from PTCs in non-IFTA regions.

Feature families and cortical regions that exhibit significant (e.g., p<0.05) associations with disease progression among the plurality of different machine learning models 911 may be combined and provided to a machine learning stage 126 as a merged feature set 920. In some embodiments, the plurality of different machine learning models 911 may determine that features from non-IFTA spatial arrangement feature families and IFTA shape feature families are prognostic of glomerular disease progression. In such embodiments, features from the non-IFTA spatial arrangement feature families and the IFTA shape feature families are combined and provided to the machine learning stage 126 as the merged feature set 920.

In some embodiments, the machine learning stage 126 may be operated upon the merged feature set 920 to identify a set of prognostic features from the merged feature set 920 as the plurality of PTC features 120 and to determine weightings (e.g., machine learning weightings) for the plurality of PTC features 120 to generate a medical prediction 128 relating to glomerular disease. In some embodiments, the machine learning stage 126 may comprise a Cox-Proportional Hazard model with a LASSO algorithm to select the set of prognostic features from the merged feature set (e.g., a top 8 features from the merged feature set). The LASSO algorithm facilitates identification of the most informative features while controlling for overfitting.

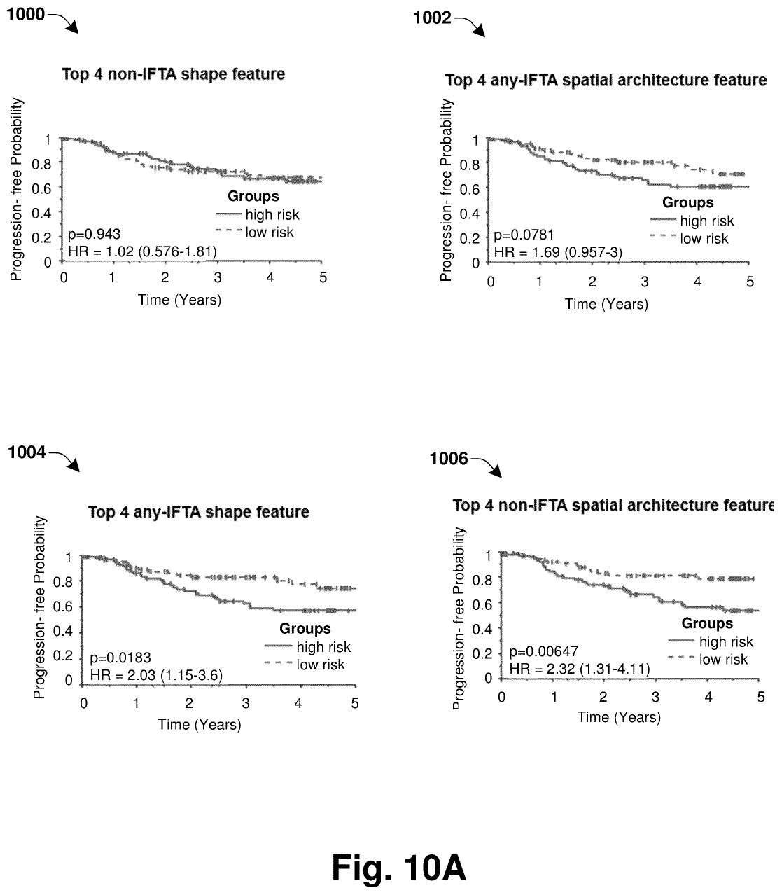

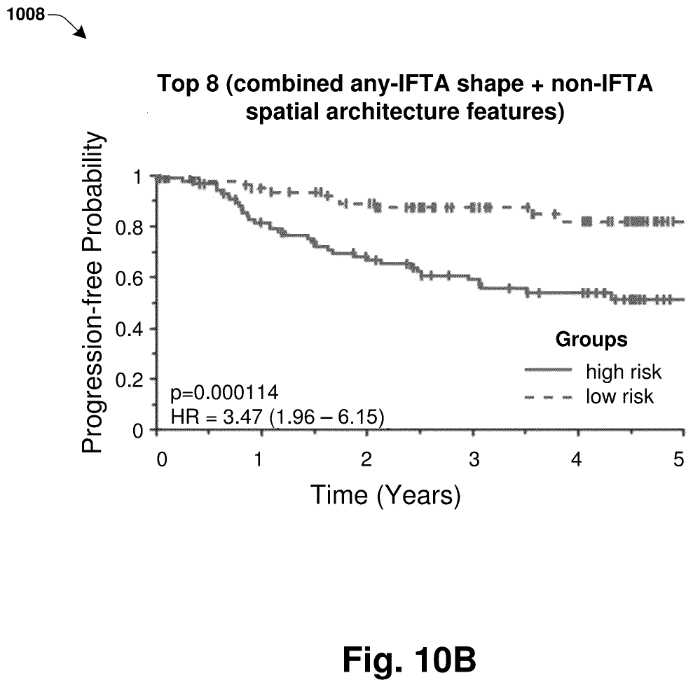

FIG. 10A illustrates graphs 1000-1006 showing exemplary Kaplan-Meier (KM) curves generated by different machine learning models for different sets of PTC features. For each of the graphs 1000-1006, the x-axis represents a time in months and y-axis represents the estimated disease free progression probability. The graphs 1000-1006 respectively have KM curves associated with a high-risk stratification group and a low-risk stratification group. The high-risk and the low-risk stratification is based on a median of risk scores generated by the disclosed glomerular disease assessment apparatus during training.

Graph 1000 illustrates KM curves associated with a top 4 most prognostic PTC shape features extracted from non-IFTA regions. In some embodiments, the KM curves of graph 1000 may be generated by a machine learning model (e.g., non-IFTA shape machine learning model 916 of FIG. 9) that has identified a top 4 PTC shape features from a pool of PTC shape features (e.g., a pool of 230 shape features from a non-IFTA region) extracted from PTCs in non-IFTA regions. The KM curves show minimal differences between the high-risk stratification group and the low-risk stratification group (e.g., an average hazard ratio (HR) of 1.02 and p-value of 0.943). Therefore, there is not a significant association between PTC shape features extracted from non-IFTA regions and glomerular disease progression.

Graph 1002 illustrates KM curves associated with a top 4 most prognostic PTC spatial arrangement (e.g., spatial architecture) features extracted from any IFTA regions. In some embodiments, the KM curves of graph 1002 may be generated by a machine learning model (e.g., IFTA spatial arrangement machine learning model 914 of FIG. 9) that has identified a top 4 PTC spatial arrangement features from a pool of PTC spatial arrangement features (e.g., a pool of 690 spatial arrangement features including 230 features from a pre-IFTA region, 230 features from a mature IFTA region, and 230 features from a combined pre-ITFA region and a mature IFTA region) extracted from PTCs in any IFTA regions (e.g., pre IFTA, mature IFTA, and combined pre-FTA and mature IFTA). The KM curves show minimal differences between the high-risk stratification group and the low-risk stratification group (e.g., an average hazard ratio (HR) of 1.69 and p-value of 0.0781). Therefore, there is not a significant association between PTC spatial architecture features extracted from any IFTA regions and glomerular disease progression.

Graph 1004 illustrates KM curves associated with a top 4 most prognostic PTC shape features extracted from any IFTA regions. In some embodiments, the KM curves of graph 1004 may be generated by a machine learning model (e.g., IFTA shape machine learning model 912 of FIG. 9) that has identified a top 4 PTC shape features from a pool of PTC shape features (e.g., a pool of 690 shape features including 230 features from a pre-IFTA region, 230 features from a mature IFTA region, and 230 features from a combined pre-ITFA region and a mature IFTA region) extracted from PTCs in any IFTA regions. The KM curves show a significant difference between the high-risk stratification group and the low-risk stratification group (e.g., an average hazard ratio (HR) of 2.03 and p-value of 0.0183). Therefore, there is a significant association between PTC shape features extracted from any IFTA regions and glomerular disease progression.

Graph 1006 illustrates KM curves associated with a top 4 most prognostic PTC spatial architecture features extracted from non-IFTA regions. In some embodiments, the KM curves of graph 1006 may be generated by a machine learning model (e.g., non-IFTA spatial arrangement machine learning model 918 of FIG. 9) that has identified a top 4 PTC spatial arrangement features from a pool of PTC spatial arrangement features (e.g., a pool of 230 spatial arrangement features from a non-IFTA region) extracted from PTCs in non-IFTA regions. The KM curves show a significant difference between the high-risk stratification group and the low-risk stratification group (e.g., an average hazard ratio (HR) of 2.32 and p-value of 0.00647). Therefore, there is a significant association between PTC shape features extracted from non-IFTA regions and glomerular disease progression.

FIG. 10B illustrates a graph 1008 showing exemplary Kaplan-Meier (KM) curves generated by a machine learning model for PTC features. In some embodiments, the KM curves of graph 1008 may be generated by a machine learning model (e.g., machine learning stage 126 of FIG. 9) that has identified a top 8 PTC features from a merged feature set including PTC shape and spatial arrangement features from different regions (e.g., as shown in FIG. 5B). Graph 1008 illustrates KM curves associated with a top 8 PTC features including PTC spatial architecture features extracted from non-IFTA regions and PTC shape features extracted from IFTA-regions. The KM curves show a significant difference between the high-risk stratification group and the low-risk stratification group (e.g., an average hazard ratio (HR) of 3.47 and p-value of 0.000114). Therefore, there is a significant association between glomerular disease progression and PTC features including spatial architecture features extracted from non-IFTA regions and shape features extracted from IFTA-regions.

As can be seen by the KM curves 1000-1008 shown in FIGS. 10A-10B, the disclosed glomerular disease assessment system improves a computer's ability to analyze medical images in a manner that accurately identifies patients that are likely to experience glomerular disease (e.g., that accurately stratifies patients that are at a high-risk vs. a low-risk of glomerular disease). The improved ability to accurately identify patients that are likely to experience glomerular disease can improve treatment of the patients.

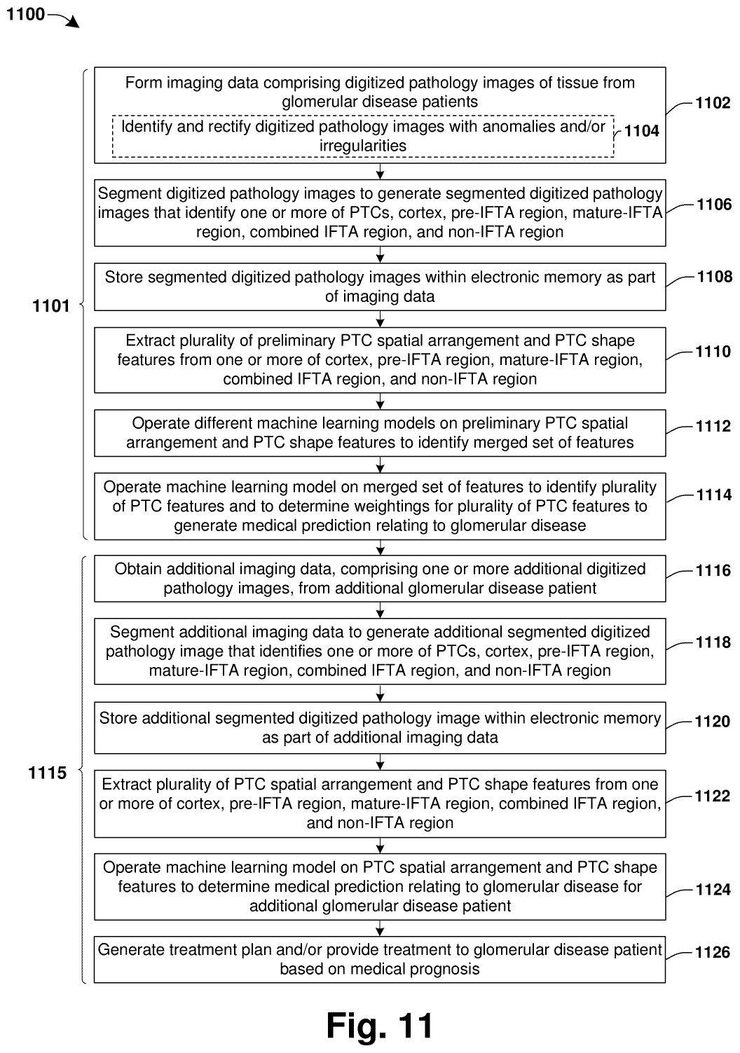

FIG. 11 illustrates a flow diagram showing some additional embodiments of a method 1100 of utilizing PTC features to generate a medical prediction of glomerular disease for a patient.

The method 1100 comprises a training phase 1101 and an application phase 1115. The training phase 1101 is configured to train a machine learning model to generate a medical prediction relating to glomerular disease. In some embodiments, the training phase 1101 may be performed according to acts 1102-1114.

At act 1102, imaging data is formed to comprise digitized pathology images of tissue from glomerular disease patients. In some embodiments, formation of the imaging data may comprise act 1104.

At act 1104, one or more digitized pathology images with anomalies and/or irregularities are identified and rectified. In some embodiments, the rectification of irregularities may include normalization of batch effects (e.g., systematic technical artifacts unrelated to biological variability).

At act 1106, the digitized pathology images may be segmented to generate one or more segmented digitized pathology images that identify one or more of peritubular capillaries (PTCs), a cortex, a pre-IFTA region, a mature-IFTA region, a combined IFTA region, and a non-IFTA region, in some embodiments.

At act 1108, the one or more segmented digitized pathology images are stored within electronic memory as part of the imaging data.

At act 1110, a plurality of preliminary PTC spatial arrangement and PTC shape features are extracted from one or more of the cortex, the pre-IFTA region, the mature-IFTA region, the combined IFTA region, and the non-IFTA region.

At act 1112, a plurality of different machine learning models are operated upon the plurality of preliminary PTC spatial arrangement features and PTC shape features to identify a merged set of features. The merged set of features identify top features within different combinations of PTC and IFTA categories. In some embodiments, the merged set of features may comprise non-IFTA spatial features and IFTA shape features.

At act 1114, a machine learning model is operated upon the merged set of features to identify a plurality of PTC features and to determine weightings for the plurality of PTC features to generate a medical prediction relating to glomerular disease.

The application phase 1115 is configured to utilize the machine learning model on an additional digitized pathology image taken from an additional glomerular disease patient. In some embodiments, the application phase 1115 may be performed according to acts 1116-1124.

At act 1116, additional imaging data, including one or more additional digitized pathology images, is obtained from an additional glomerular disease patient.

At act 1118, the additional imaging data may be segmented to generate one or more additional segmented digitized pathology images that identify one or more of PTCs, a cortex, a pre-IFTA region, a mature-IFTA region, a combined IFTA region, and a non-IFTA region, in some embodiments.

At act 1120, the one or more additional segmented digitized pathology images are stored within electronic memory as part of the additional imaging data.

At act 1122, a plurality of PTC spatial arrangement and PTC shape features are extracted from one or more of the cortex, the pre-IFTA region, the mature-IFTA region, the combined IFTA region, and the non-IFTA region within the one or more additional digitized pathology images.

At act 1124, the plurality of PTC spatial arrangement and PTC shape features are operated upon by the machine learning model to generate a medical prediction relating to glomerular disease within the additional glomerular disease patient.

At act 1126, a treatment plan may be generated and/or a treatment may be provided to the additional glomerular disease patient based upon the medical prediction, in some embodiments. For example, based upon the medical prediction it may be determined that certain treatments (e.g., medications, dialysis, a kidney transplant, etc.) may be beneficial to the additional glomerular disease patient and the treatment may be applied to the additional glomerular disease patient.

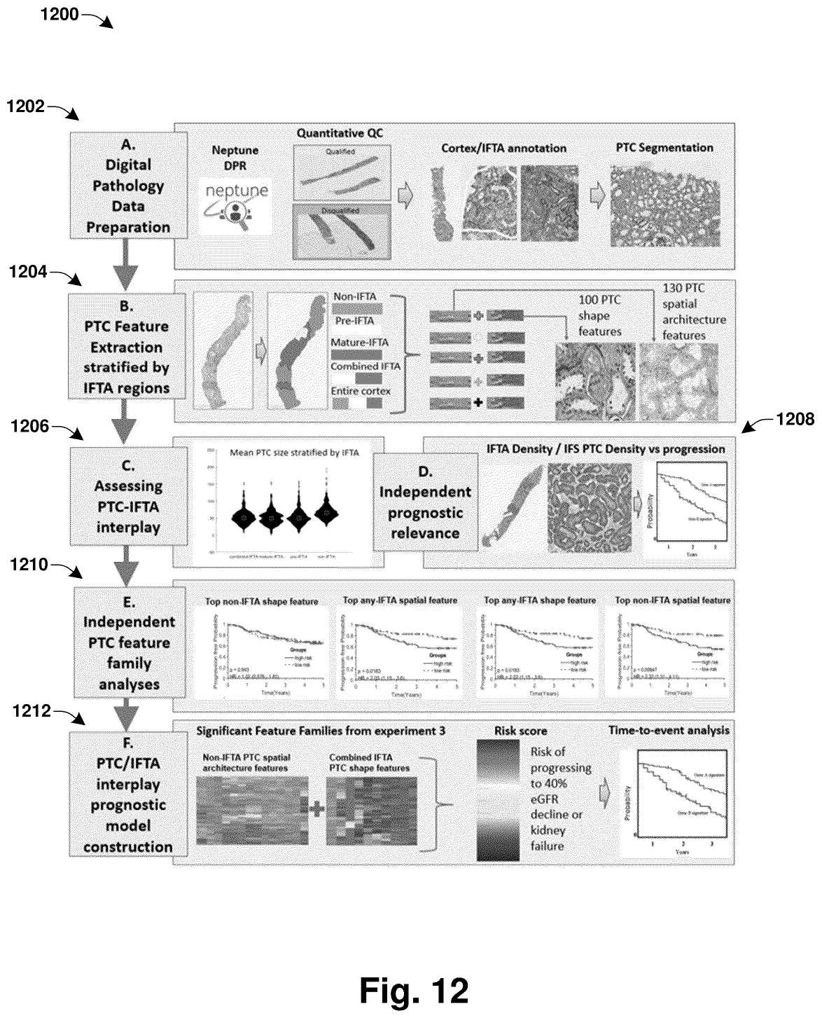

FIG. 12 illustrates some embodiments of a flow chart 1200 of a method of generating a glomerular disease assessment apparatus configured to generate a medical prediction relating to glomerular disease.

As shown in flow chart 1200, the process encompasses stages 1202-1212. At stage 1202, digital pathology image preparation is performed. In some embodiments, digital pathology image preparation comprises performing quantitative quality control on digitized pathology images including PAS-stained WSIs from a digital pathology repository. Segmentation is performed to identify one or more regions of interest including pre-IFTA regions, mature IFTA regions, cortical regions, and/or PTCs across the cortical regions on the digitized pathology images. In some embodiments, a validated machine learning (DL) model may be used to perform the segmentations.

At stage 1204, a plurality of PTC features are extracted from the one or more regions of interest. The plurality of PTC features may include quantitative PTC shape and PTC spatial arrangement (e.g., spatial architecture) features extracted from PTCs in various regions, including the cortical regions, pre-IFTA regions, mature IFTA regions, combined IFTA regions, and non-IFTA regions. The plurality of PTC features describe a complexity of a cortical microvasculature and an interstitial microenvironment.

At stage 1206, an IFTA modulatory effect assessment is performed. The IFTA modulatory effect assessment explores an interplay between IFTA and PTC by analyzing a distribution of PTC characteristics across different IFTA-based categories.

At stage 1208, a prognostic relevance assessment is performed. The prognostic relevance assessment makes an independent assessment of prognostic relevance of PTC features and/or PTC density features. For example, the prognostic relevance assessment may make an independent assessment of prognostic relevance of pre-IFTA density, mature IFTA density, combined IFTA density, and PTC interstitial fractional space density by associating each entity with disease progression using an unadjusted Cox-proportional hazards models.

At stage 1210, machine learning techniques are employed to assess each feature family categorized by PTC location in relation to IFTA.

At stage 1212, the most significant features from relevant feature families were used to construct a multi-feature prognostic model using the LASSO feature selection method. This resulted in the generation of a risk score to predict the time to 40% eGFR decline or kidney failure in patients.

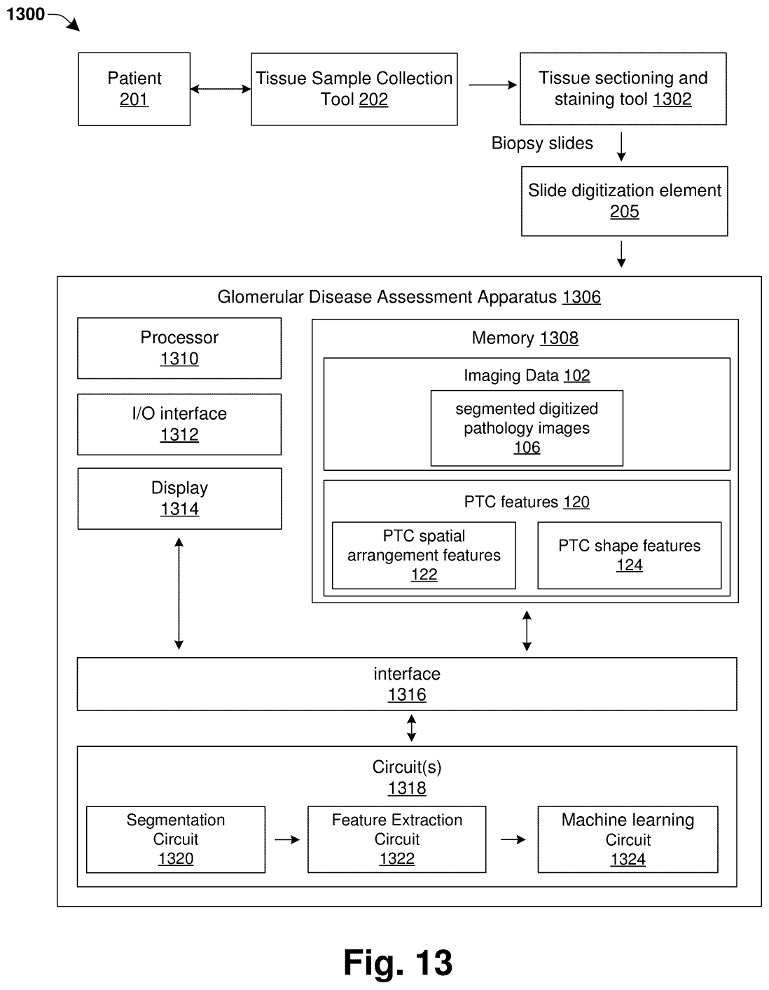

FIG. 13 illustrates a block diagram of some embodiments of a glomerular disease assessment system 1300 comprising a machine learning model configured to utilize PTC features to generate a medical prediction of glomerular disease for a patient.

The glomerular disease assessment system 1300 comprises a glomerular disease assessment apparatus 1306. The glomerular disease assessment apparatus 1306 is coupled to a slide digitization element 205 that is configured to obtain digitized images (e.g., whole slide images) of tissue samples collected from a glomerular disease patient 201. In some embodiments, one or more tissue samples (e.g., a tissue block) may be obtained using a tissue sample collection tool 202 (e.g., a cannular, forceps, needle, punch, or the like). The one or more tissue samples may be provided to a tissue sectioning and staining tool 1302. In some embodiments, the tissue sectioning and staining tool 1302 may be configured to slice the one or more tissue samples into thin slices that are placed on transparent slides (e.g., glass slides) to generate biopsy slides. The tissue on the biopsy slides is then stained by applying a dye (e.g., a periodic acid Schiff (PAS) stain). The dye may be applied on the posterior and anterior border of the sample tissues to locate diseased cells, tumorous cells, and/or other pathological cells. The slide digitization element 205 is configured to convert the biopsy slides to digitized pathology data (e.g., whole slide images). In some embodiments, the slide digitization element 205 may comprise an image sensor (e.g., a photodiode, CMOS image sensor, or the like) that is configured to capture a digital image of the biopsy slides.

The glomerular disease assessment apparatus 1306 comprises a processor 1310 and a memory 1308. The processor 1310 can, in various embodiments, comprise circuitry such as, but not limited to, one or more single-core or multi-core processors. The processor 1310 can include any combination of general-purpose processors and dedicated processors (e.g., graphics processors, application processors, etc.). The processor(s) 1310 can be coupled with and/or can comprise memory (e.g., memory 1308) or storage and can be configured to execute instructions stored in the memory 1308 or storage to enable various apparatus, applications, or operating systems to perform operations and/or methods discussed herein.

Memory 1308 can be further configured to store imaging data 102 comprising the one or more digitized pathology images obtained by the slide digitization element 205. The one or more digitized pathology images may comprise a plurality of pixels, each pixel having an associated intensity. In some additional embodiments, the one or more digitized pathology images may be stored in the memory 1308 as one or more training sets of digitized pathology images for training a classifier and/or one or more validation sets (e.g., test sets) of digitized pathology images.

The glomerular disease assessment apparatus 1306 also comprises an input/output (I/O) interface 1312 (e.g., associated with one or more I/O devices), a display 1314, one or more circuits 1318, and an interface 1316 that connects the processor 1310, the memory 1308, the I/O interface 1312, the display 1314, and the one or more circuits 1318. The I/O interface 1312 can be configured to transfer data between the memory 1308, the processor 1310, the one or more circuits 1318, and external devices (e.g., slide digitization element 205).

In some embodiments, the one or more circuits 1318 may comprise hardware components. In other embodiments, the one or more circuits 1318 may comprise software components. The one or more circuits 1318 can comprise a segmentation circuit 1320 (e.g., including one or more deep learning circuits) configured to perform a segmentation operation on one or more digitized pathology images within the imaging data 102 to generate one or more segmented digitized pathology images 106 respectively identifying one or more regions of interest (e.g., a cortex, a pre-IFTA region, a mature IFTA region, a combined IFTA region, and a non-IFTA region) and PTCs. In some embodiments, the one or more segmented digitized pathology images 106 may comprise binary masks, which may be stored in the memory 1308.

In some additional embodiments, the one or more circuits 1318 may further comprise a feature extraction circuit 1322 configured to extract a plurality of PTC features 120 from the one or more segmented digitized pathology images 106. The plurality of PTC features 120 may include PTC spatial arrangement features 122 and PTC shape features 124. In some embodiments, the plurality of PTC features 120 may include PTC spatial arrangement features 122 extracted from the non-IFTA region and PTC shape features extracted from the combined IFTA region. The PTC features 120 may be stored in the memory 1308.

In some embodiments, the one or more circuits 1318 may further comprise a machine learning circuit 1324 configured to operate a machine learning model (e.g., a Cox-proportional Hazard model) upon the plurality of PTC features 120 to generate a medical prediction 128 relating to glomerular disease.

Therefore, the present disclosure relates to a method and associated apparatus that utilizes a plurality of peritubular capillary (PTC) features extracted from digitized pathology images to generate a medical prediction relating to glomerular disease.

In some embodiments, the present disclosure relates a method, including accessing a digitized pathology image stored in a memory, the digitized pathology image being from a glomerular disease patient; extracting a plurality of peritubular capillary (PTC) features from the digitized pathology image, the plurality of PTC features include a plurality of PTC spatial architecture features and a plurality of PTC shape features; and providing the plurality of PTC features to a machine learning stage, the machine learning stage being configured to generate a medical prediction relating to glomerular disease based upon the plurality of PTC features.

In other embodiments, the present disclosure relates to a non-transitory computer-readable medium storing computer-executable instructions that, when executed, cause a processor to perform operations, including accessing a digitized pathology image of a glomerular disease patient stored in a memory, the digitized pathology image being segmented to identify one or more interstitial fibrosis and tubular atrophy (IFTA) regions and one or more non-IFTA regions; extracting a plurality of peritubular capillary (PTC) features from the one or more IFTA regions and the one or more non-IFTA regions of the digitized pathology image; and providing the plurality of PTC features to a machine learning stage, the machine learning stage being configured to generate a risk score based upon the plurality of PTC features and being indicative of glomerular disease progression.

In yet other embodiments, the present disclosure relates to an apparatus, including a memory configured to store a digitized pathology image, the digitized pathology image being segmented to identify one or more interstitial fibrosis and tubular atrophy (IFTA) regions and one or more non-IFTA regions, the one or more IFTA regions including pre-IFTA regions comprising tubules having some characteristics of originating tubules and mature IFTA regions comprising substantially fully atrophic tubules; a feature extraction tool configured to extract a plurality of peritubular capillary (PTC) features from the IFTA and the non-IFTA regions of the digitized pathology image; and a machine learning stage configured to generate a medical prediction relating to glomerular disease based upon the plurality of PTC features.

Examples herein can include subject matter such as an apparatus, including a digital whole slide scanner, a CT system, an MRI system, a personalized medicine system, a CADx system, a processor, a system, circuitry, a method, means for performing acts, steps, or blocks of the method, at least one machine-readable medium including executable instructions that, when performed by a machine (e.g., a processor with memory, an application-specific integrated circuit (ASIC), a field programmable gate array (FPGA), or the like) cause the machine to perform acts of the method or of an apparatus or system, according to embodiments and examples described.

References to “one embodiment”, “an embodiment”, “one example”, and “an example” indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable storage device”, as used herein, refers to a device that stores instructions or data. “Computer-readable storage device” does not refer to propagated signals. A computer-readable storage device may take forms, including, but not limited to, non-volatile media, and volatile media. Non-volatile media may include, for example, optical disks, magnetic disks, tapes, and other media. Volatile media may include, for example, semiconductor memories, dynamic memory, and other media. Common forms of a computer-readable storage device may include, but are not limited to, a floppy disk, a flexible disk, a hard disk, a magnetic tape, other magnetic medium, an application specific integrated circuit (ASIC), a compact disk (CD), other optical medium, a random access memory (RAM), a read only memory (ROM), a memory chip or card, a memory stick, and other media from which a computer, a processor or other electronic device can read.

“Circuit”, as used herein, includes but is not limited to hardware, firmware, software in execution on a machine, or combinations of each to perform a function(s) or an action(s), or to cause a function or action from another logic, method, or system. A circuit may include a software controlled microprocessor, a discrete logic (e.g., ASIC), an analog circuit, a digital circuit, a programmed logic device, a memory device containing instructions, and other physical devices. A circuit may include one or more gates, combinations of gates, or other circuit components. Where multiple logical circuits are described, it may be possible to incorporate the multiple logical circuits into one physical circuit. Similarly, where a single logical circuit is described, it may be possible to distribute that single logical circuit between multiple physical circuits.

To the extent that the term “includes” or “including” is employed in the detailed description or the claims, it is intended to be inclusive in a manner similar to the term “comprising” as that term is interpreted when employed as a transitional word in a claim.

Throughout this specification and the claims that follow, unless the context requires otherwise, the words ‘comprise’ and ‘include’ and variations such as ‘comprising’ and ‘including’ will be understood to be terms of inclusion and not exclusion. For example, when such terms are used to refer to a stated integer or group of integers, such terms do not imply the exclusion of any other integer or group of integers.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

While example systems, methods, and other embodiments have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and other embodiments described herein. Therefore, the invention is not limited to the specific details, the representative apparatus, and illustrative examples shown and described. Thus, this application is intended to embrace alterations, modifications, and variations that fall within the scope of the appended claims.

What is claimed is:

1. A method, comprising:
accessing a digitized pathology image stored in a memory, wherein the digitized pathology image is from a glomerular disease patient;
extracting a plurality of peritubular capillary (PTC) features from the digitized pathology image, wherein the plurality of PTC features include a plurality of PTC spatial architecture features and a plurality of PTC shape features; and
providing the plurality of PTC features to a machine learning stage, wherein the machine learning stage is configured to generate a medical prediction relating to glomerular disease based upon the plurality of PTC features.

2. The method of claim 1,
wherein the digitized pathology image is segmented to identify one or more interstitial fibrosis and tubular atrophy (IFTA) regions and one or more non-IFTA regions; and
wherein the plurality of PTC features are extracted from the one or more IFTA regions and the one or more non-IFTA regions.

3. The method of claim 2, wherein the one or more IFTA regions include pre-IFTA regions comprising tubules having some characteristics of originating tubules and mature IFTA regions comprising substantially fully atrophic tubules.

4. The method of claim 2, wherein the plurality of PTC features include PTC spatial arrangement features extracted from the one or more non-IFTA regions and PTC shape features extracted from the one or more IFTA regions.

5. The method of claim 2, wherein the plurality of PTC shape features include a Fourier descriptor of the one or more IFTA regions, a mean PTC eccentricity of the one or more IFTA regions, a Voronoi diagram area of the non-IFTA regions, a Delaunay triangle area of the one or more non-IFTA regions, and an average distance of a first PTC of the plurality of PTCs to nearest neighbors within the one or more non-IFTA regions.

6. The method of claim 1,
wherein the digitized pathology image is segmented to identify regions of interest including a cortex, one or more interstitial fibrosis and tubular atrophy (IFTA) regions, and one or more non-IFTA regions; and
wherein the plurality of PTC features are extracted from the regions of interest.

7. The method of claim 1, further comprising:
determining an IFS region within the digitized pathology image, wherein determining the IFS region comprises:
segmenting the digitized pathology image to identify a cortex, glomeruli, tubules, and arteries; and
subtracting the glomeruli, the tubules, and the arteries from the cortex to determine the IFS region.

8. The method of claim 7, further comprising:
determining PTC density within the IFS region, wherein the machine learning stage is configured to generate the medical prediction relating to glomerular disease based upon the PTC density within the IFS region.

9. The method of claim 1, further comprising:
taking a tissue sample from the glomerular disease patient;
separating the tissue sample into a plurality of tissue slices;
staining one or more of the plurality of tissue slices to form one or more stained tissue slices;
forming one or more biopsy slides using the one or more stained tissue slices; and
digitizing the one or more stained tissue slices to form the digitized pathology image.

10. A non-transitory computer-readable medium storing computer-executable instructions that, when executed, cause a processor to perform operations, comprising:
accessing a digitized pathology image of a glomerular disease patient stored in a memory, wherein the digitized pathology image is segmented to identify one or more interstitial fibrosis and tubular atrophy (IFTA) regions and one or more non-IFTA regions;
extracting a plurality of peritubular capillary (PTC) features from the one or more IFTA regions and the one or more non-IFTA regions of the digitized pathology image; and
providing the plurality of PTC features to a machine learning stage, wherein the machine learning stage is configured to generate a risk score based upon the plurality of PTC features, the risk score being indicative of glomerular disease progression.

11. The non-transitory computer-readable medium of claim 10, wherein the one or more IFTA regions include pre-IFTA regions comprising tubules having some characteristics of originating tubules, mature IFTA regions comprising substantially fully atrophic tubules, and combined IFTA regions including both the pre-IFTA regions and the mature IFTA regions.

12. The non-transitory computer-readable medium of claim 11, wherein the plurality of PTC features include PTC spatial arrangement features extracted from the one or more non-IFTA regions and PTC shape features extracted from the one or more IFTA regions.

13. The non-transitory computer-readable medium of claim 11, wherein the plurality of PTC features include PTC spatial arrangement features extracted from the one or more non-IFTA regions and PTC shape features extracted from the combined IFTA regions.

14. The non-transitory computer-readable medium of claim 11, wherein the plurality of PTC features include one or more of a Fourier descriptor of the one or more IFTA regions, a mean PTC eccentricity of the one or more IFTA regions, a Voronoi diagram area of the non-IFTA regions, a Delaunay triangle area of the one or more non-IFTA regions, and an average distance of a first PTC of the plurality of PTCs to nearest neighbors within the one or more non-IFTA regions.

15. The non-transitory computer-readable medium of claim 10, wherein the risk score is used to form a treatment plan, the treatment plan being used to apply a treatment to the glomerular disease patient.

16. A glomerular disease assessment system, comprising:
a memory configured to store a digitized pathology image, wherein the digitized pathology image is segmented to identify one or more interstitial fibrosis and tubular atrophy (IFTA) regions and one or more non-IFTA regions, the one or more IFTA regions including pre-IFTA regions comprising tubules having some characteristics of originating tubules and mature IFTA regions comprising substantially fully atrophic tubules;
a feature extraction tool configured to extract a plurality of peritubular capillary (PTC) features from the IFTA and the non-IFTA regions of the digitized pathology image; and
a machine learning stage configured to generate a medical prediction relating to glomerular disease based upon the plurality of PTC features.

17. The glomerular disease assessment system of claim 16, wherein the plurality of PTC features include PTC spatial arrangement features extracted from the one or more non-IFTA regions and PTC shape features extracted from the one or more IFTA regions.

18. The glomerular disease assessment system of claim 16, wherein the plurality of PTC features include a Fourier descriptor of the one or more IFTA regions.

19. The glomerular disease assessment system of claim 16, wherein the plurality of PTC features include a Fourier descriptor of the one or more IFTA regions, a mean PTC eccentricity of the one or more IFTA regions, a Voronoi diagram area of the non-IFTA regions, a Delaunay triangle area of the one or more non-IFTA regions, and an average distance of a first PTC of the plurality of PTCs to nearest neighbors within the one or more non-IFTA regions.

20. The glomerular disease assessment system of claim 16, further comprising:
a slide digitization element having a slide reception surface configured to receive one or more biopsy slides and an image sensor disposed within a housing and configured to generate the digitized pathology image of the one or more biopsy slides on the slide reception surface.
